(19) United States
(12) Patent Application Publication
(10) Pub. No.: US 2008/0101164 A1
(43) Pub. Date: May 1, 2008

(54) CLOCK FACE RECORDING STATUS INDICATOR

(76) Inventor: James E. Hicks, Laguna Beach, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/555,085

(22) Filed: Oct. 31, 2006

(51) Int. Cl. G04B 19/00

(52) U.S. Cl. 368/223

(57) ABSTRACT

A recording status indicator that utilizes the familiar pattern of an analog clock face to convey the length and viewing location of an individual recorded program. The indicator is preferably overlaid over the program material on the television monitor or other display in a corner of the screen or some other non-obtrusive location on the screen. In a preferred embodiment, a “clock face” status indicator preferably includes a clock face, a recording starting point marker preferably represented at the top of the clock face, a thirty minute marker represented at the bottom of the clock face, fifteen and forty-five minute markers represented about the sides of the clock face, a first recording marker to show the current recording point or time of the program, and a second recording marker to show how much of the recording has been viewed (or the time location within the recording).

### FIELD

The present invention relates generally to status indicators for recording systems, and more particularly to a recording status indicator that correlates the length and viewing location with time.

### BACKGROUND

Personal Video Recorders or Digital Video Recorders (collectively “PVR”) have grown significantly in popularity in recent years. In using such a device, a viewer may “pause” a live broadcast for a few minutes and then return to viewing the program from the “pause” point or “rewind” the live broadcast and “replay” a portion of the live broadcast that has been recorded and rewound. The user also may make a “time-shift recording” of a broadcasted program to be viewed sometime after the actual broadcast.

For a viewer using a PVR, it is useful to know the relationship of the current viewing point and the “real-time” of the live broadcast or the relationship of the start and end of the recording. Current systems typically provide a status indicator viewable on a television monitor or some display by a viewer who is using the PVR. Conventional indicators include, e.g., “bar-graph” type meters and “gas gauge” type meters. See e.g., U.S. Pat. No. 6,847,778 and published U.S. Patent Application 2002/0054750. However, such indicators are not quickly and easily interpreted by the viewer.

Therefore, it would be desirable to provide a system and method that provides a recording status indicator that correlates the length of a recording and viewing location within the recording with time.

### SUMMARY

Improved methods, systems and apparatus for a recording status indicator that correlates the length of a recording and the viewing location within the recording with time. These embodiments are examples only and are not intended to limit the invention.

The recording status indicator provided utilizes the familiar pattern of an analog clock face to convey the length and viewing location of an individual recorded program. The indicator, using the system's on screen display control, is preferably overlaid over the program material on the television monitor or other display, preferably in a corner of the screen or some other non-obtrusive location on the screen. In a preferred embodiment, a “clock face” status indicator preferably includes a clock face, a recording starting point marker preferably represented at the top of the clock face, a thirty minute marker represented at the bottom of the clock face like a minute hand of an analogue clock, fifteen and forty-five minute markers similarly represented at the sides of the clock face, a first recording marker to show the current recording point or time of the program, and a second recording marker to show how much of the recording has been viewed (or the time location within the recording).

In another embodiment, the clock face indicator is convertible from a 60 minute clock face to a 12-hour clock face as the recorded time extends beyond one hour. Alternatively, the clock face indicator is convertible from a single-hour 60 minute clock face to a multi-hour 60 minute clock face. As the remaining program recorded time decreases below one hour, the clock face indicator in convertible back to a single hour, 60 minute clock face.

In another embodiment, the first and second recording markers include digital time indicators.

In yet another embodiment, a 12-hour clock face is adapted to provide recording status for a “paused” or real time recording.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a schematic of a preferred embodiment of a “clock face” recording status on-screen indicator.

FIG. 2 is a schematic of an alternative embodiment of the clock face indicator provided in FIG. 1.

FIG. 3 is a schematic of another alternative embodiment of the clock face indicator provided in FIG. 1.

FIG. 4 is a schematic of a yet another alternative embodiment of the clock face indicator provided in FIG. 1.

FIG. 5 is a schematic of an alternative embodiment of the clock face indicator provided in FIG. 4.

FIG. 6 is a schematic of an alternative embodiment of the clock face indicator provided in FIG. 3.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

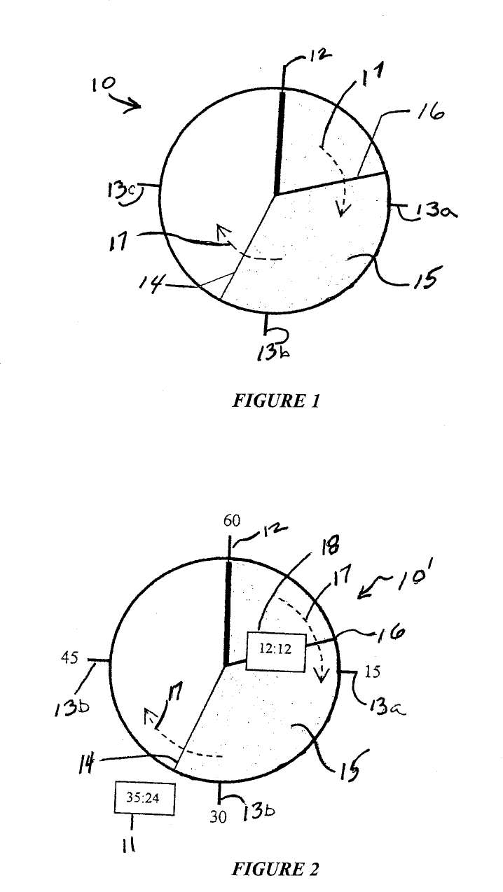

Devices, systems and methods for a recording status indicator that correlates the length of a recording and the viewing location within the recording with time, are described herein. Turning in detail to the figures, the provided recording status indicator utilizes a familiar pattern of an analog clock face to convey the length and viewing location of an individual recorded program. Using a device's on screen display system, the indicator is preferably overlaid over the program material on the television monitor or other display, preferably in a corner of the screen or some other non-obtrusive location on the screen. As depicted in FIG. 1, a “clock face” status indicator 10 preferably includes a clock face 15 and a recording starting point marker 12 (i.e., zero minutes of program recording) preferably represented at the top of the clock face 15. (As one skilled in the art will readily recognize, the starting point marker 12 also represents 60 minutes of program recording.) A thirty minute marker 13b is represented at the bottom of the clock face 15 like the minute hand of a clock. Fifteen and forty-five minute markers 13a and 13c are similarly represented at the sides of the clock face 15. A first recording marker 14 is preferably provided to show the current recording point or recording time of the program. As depicted in FIG. 1, the shaded region of the clock face 15 and the first recording marker 14 indicate that about 35 minutes of program material has been recorded. A second recording marker 16 is preferably provided to show how much of the recording has been viewed (or the time location within the recording). As depicted, the second recording marker 16 is located at about 12 minutes. Arrows 17 are preferably provided to show the direction the markers are propagating around the clock face during operation of the recording and other related functions such as “rewind”, “play” and “fast forward”.

For more precise time information, and especially when “rewinding” or “fast forwarding” to find an exact point or time location within the recording, it may be desirable to add the exact digital times to the on-screen clock face indicator. As depicted in FIG. 2 in an alternative embodiment of the clock face indicator 10′, digital time indicators (recording time 11 and time location 18) are associated with the first and second recording markers. Preferably, the digital time indicators 11 and 18 travel around the clock face 15 with the first and second recording markers 14 and 16 to clearly indicate to which marker each digital time indicator is associated. To limit the potential for confusion when the digital time indicators 11 and 18 and first and second recording markers 14 and 16 are in close proximity, the digital time indicator for recording time 11 is preferably always positioned on the outside of the clock face 15 while the digital time indicator for the time location 18 is preferably always on the inside of the clock face 15, or vice versus.

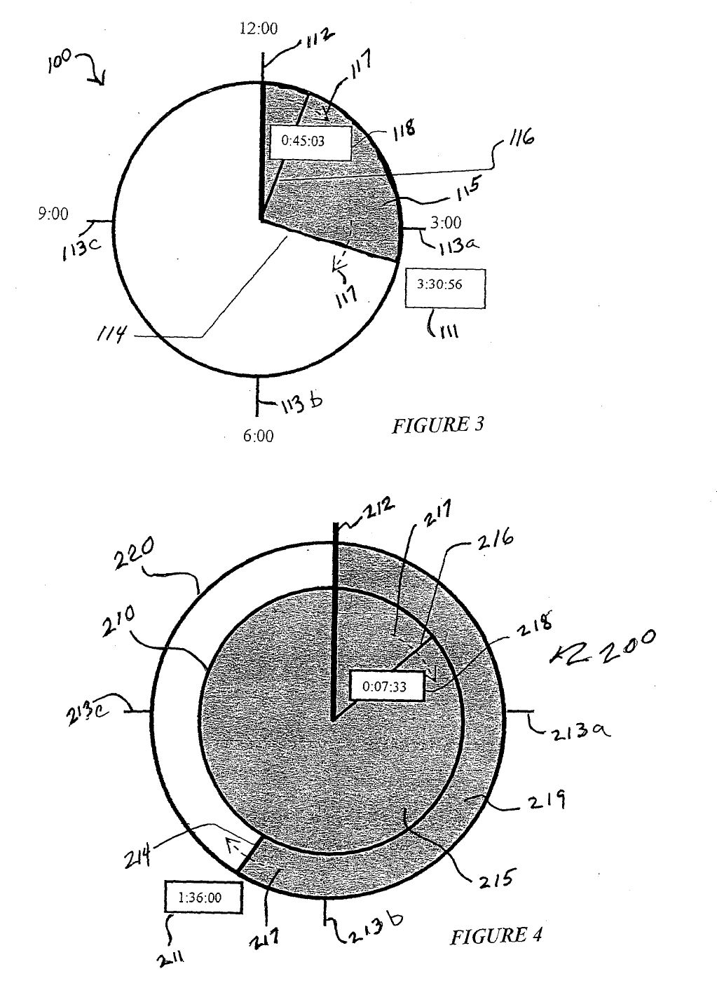

As illustrated in FIG. 3, when a recording is longer than 60 minutes, the clock face indicator switches to a “12-hour” clock face indicator 100 with a 12-hour clock face 115 where the markers correspond to the hour hand of a typical analogue clock. The clock face 115 is preferable convertible back to a single hour, 60 minute clock face as the remaining recorded time decreases below one hour.

As depicted, the components of the “clock face” status indicator 100 are preferably substantially the same with the exception of being applied to a 12-hour clock face. The 12-hour clock face 115 includes a recording starting point marker 112 preferably represented as extending to and from the top of the clock face 115, i.e., at 12:00 on an analogue clock face. Three hour interval markers 113a, 113b and 113c are represented about the clock face 115 at 3:00, 6:00 and 9:00 respectively. A first recording marker 114 is preferably provided to show the current recording point or recording time of the program. As depicted in FIG. 2, the shaded region of the clock face 115 and the first recording marker 114 indicate that about 3 hours and 30 minutes of material has been recorded. A second recording marker 116 is preferably provided to show how much of the recording has been viewed (or the time location within the recording). As depicted, the second recording marker 116 is located at about 45 minutes. Arrows 117 are preferably provided to show the direction the markers are propagating around the clock face during operation of the recording and other related functions such as “rewind”, “play” and “fast forward”.

When the transition from minutes to hours is first made and the clock face switches from a 60 minute clock face 15 to a 12-hour clock face 115, the time is substantially compressed such that the first and second markers 114 and 116 will appear to almost coincide. To avoid any confusion that could be caused by such a transition, an alternative embodiment of a clock face indicator 200, as depicted in FIG. 4, preferably includes a first (or first hour) 60 minute clock face indicator 210 overlaying a second (or second hour) 60 minute clock face indicator 220 (or, stated differently, the second 60 minute clock face indicator 220 surrounds the first 60 minute clock face indicator 210). At transition as the recorded program time exceeds one hour, the relative position of the first and second markers 214 and 216 do not change, and thus do not disorient the viewer, as the clock face changes to include a first clock face 215 superimposed on and concentric with a second clock face 219.

As with the clock face indicators 10 and 100 shown in FIGS. 1 and 3, the clock face indicator 200 includes components that are preferably substantially the same with the exception of being applied to first and second 60-minute clock faces 215 and 219. The clock faces 215 and 219 include a recording starting point marker 212 preferably represented as extending up to and from the top of the clock faces 215 and 219. Fifteen minute interval markers 213a, 213b and 213c are represented about the outer clock face 219 at fifteen, thirty and forty-five minutes respectively. A first recording marker 214 is preferably provided to show the current recording point or recording time of the recorded program. The shaded regions of the clock faces 215 and 219, the first recording marker 214 and digital time indicator 211 indicate that 1 hour and 36 minutes of material has been recorded. A second recording marker 216 and digital time indicator 218 are preferably provided to show how much of the recording has been viewed (or the time location within the recording). As depicted, the second recording marker 216 is located at about seven minutes. Arrows 217 are preferably provided to show the direction the markers are propagating around the clock face during operation of the recording and other related functions such as “rewind”, “play” and “fast forward”.

Turning to FIG. 5, the 60-minute clock face embodiment can be extended to provide the status of three or more hours of recorded material. A multi-hour 60-minute clock face indicator 300 is shown to include a first (or first hour) 60 minute clock face indicator 310 overlaying a second (second hour) 60 minute clock face indicator 320, which in turn overlays a third (third hour) 60 minute clock face indicator 320. At transition as the recording time extends from less than an hour to greater than an hour and from less than two hours to greater than two hours, the relative position of the first and second markers 314 and 316 do not change, and thus do not disorient the viewer, as the clock face changes to include a first clock face 315 superimposed on and concentric with a second clock face 319, which in turn is superimposed on and concentric with a third clock face 331. The clock face indicator 300 preferably includes substantially the same components with the exception of being applied to first, second and third 60-minute clock faces 315, 319 and 331. The clock faces 315, 219 and 331 include a recording starting point marker 312 preferably represented as extending to and from the top of the clock faces 315, 219 and 331. Fifteen minute interval markers 313a, 313b and 313c are represented about the outer clock face 331 at fifteen, thirty and forty-five minutes respectively. A first recording marker 314 is preferably provided to show the current recording point or recording time of the recorded program. The shaded regions of the clock faces 315, 219 and 331, the first recording marker 314 and digital time indicator 311 indicate that about 2 hours and 5 minutes of material has been recorded. A second recording marker 316 and digital time indicator 318 are preferably provided to show how much of the recording has been viewed (or the time location within the recording). As depicted, the second recording marker 316 is located at about one hour and 35 minutes. Arrows 317 are preferably provided to show the direction the markers are propagating around the clock face during operation of the recording and other related functions such as “rewind”, “play” and “fast forward”.

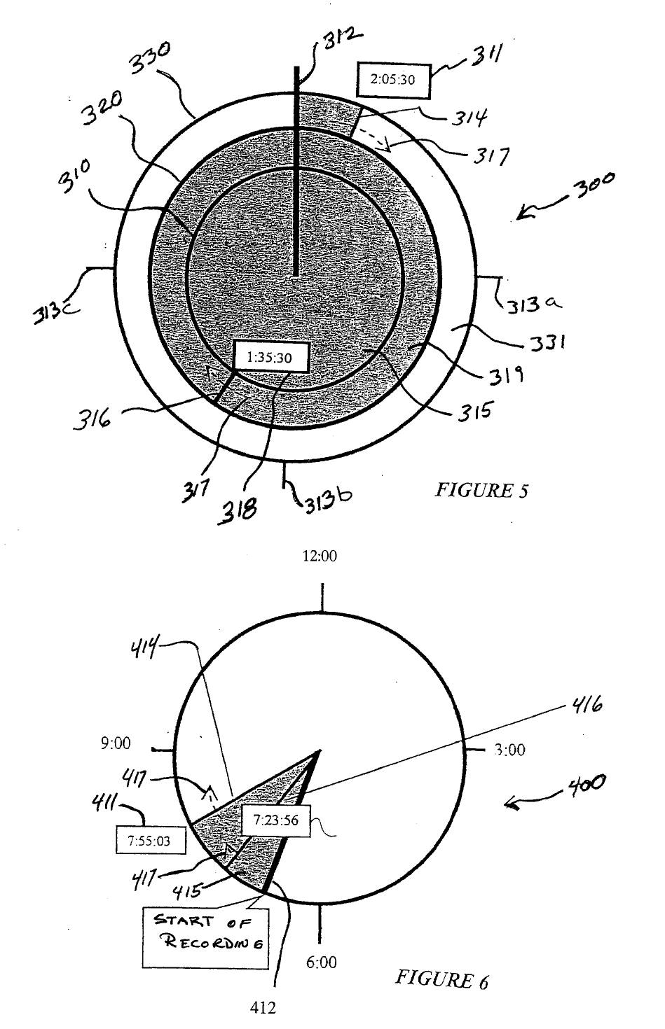

Referring to FIG. 6, an embodiment of a clock face indicator 400 is provided to address real-time or “paused” recordings using a 12-hour clock face 415 (similar to the clock face 115 of the clock face indicator 100 provided in FIG. 3). A starting point indicator 412 is provided and positioned to provide real time or paused recordings. A first recording marker 414 and corresponding digital time indicator 411 show the current time as the program is being recorded, while a second recording marker 416 and corresponding digital time indicator 418 show the time location within the live or original broadcast for the scene being viewed. As discussed above, arrows 417 are preferably provided to show the direction the markers are propagating around the clock face during operation of the recording and other related functions such as “rewind”, “play” and “fast forward”.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A recording status indicator displayable on a television monitor or other display and viewable by a viewer using a recording device, comprising
a clock face,
a first recording marker positioned on the clock face and indicating the recording time of a recorded program, and
a second recording marker positioned on the clock face and indicating the playback or viewing time location within the recording.

2. The indicator of claim 1 further comprising a recording start point indicator positioned on the clock face.

3. The indicator of claim 2 wherein the recording start point indicator is positioned at the top of the clock face.

4. The indicator of claim 3 further comprising a thirty minute marker positioned at the bottom of the clock face.

5. The indicator of claim 4 further comprising fifteen and forty-five minute markers position on the clock face.

6. The indicator of claim 1 further comprising first and second digital time indicators associated with the first and second recording markers respectively.

7. The indicator of claim 1 wherein the clock face is a sixty minute clock face.

8. The indicator of claim 7 wherein the sixty minute clock face is convertible to a twelve hour clock face as the recorded program time exceeds one hour.

9. The indicator of claim 8 wherein the twelve hour clock face is convertible to a sixty minute clock face as the remaining recorded program time decreases below one hour.

10. The indicator of claim 7 wherein the clock face is convertible to a multi-hour sixty minute clock face.

11. The indicator of claim 10 further comprises a first sixty minute clock face overlaying a second sixty minute clock face.

12. The indicator of claim 11 wherein the clock face is convertible to a single hour sixty minute clock face from a multi-hour 60 minute clock face.

13. A method for indicating the status of a recording on the screen of a television monitor or other display device comprising the steps of
displaying a clock face recording status indicator on a display screen;
displaying a recording time indicator on the clock face of the clock face indicator, and
displaying a time location within recording indicator on the clock face.

14. The method of claim 13 wherein the clock face is a sixty minute clock face.

15. The method of claim 14 further comprising the step of converting the clock face from a sixty minute clock face to a twelve hour clock face as the program recording time exceeds one hour.

16. The method of claim 15 further comprising the step of converting the twelve hour clock face to a sixty minute clock face as the remaining program recorded time reduces below one hour.

17. The method of claim 14 further comprising the step of converting the clock face from a single hour, sixty minute clock face to a multi-hour, sixty minute clock face as the program recording time exceeds one hour.
